(19) United States
(12) Patent Application Publication
(10) Pub. No.: US 2006/0240985 A1
(43) Pub. Date: Oct. 26, 2006

(54) High performance adjuvant composition used for the formulation of herbicides based on N-phosphonomethyl glycine and its salts

(76) Inventor: Valter Lopes Moreno, Santo Andre (BR)

Correspondence Address: BAKER, DONELSON, BEARMAN, CALDWELL & BERKOWITZ, SUITE 3100 SIX CONCOURSE PARKWAY, ATLANTA, GA, 30328, US

(21) Appl. No.: 11/362,357

(22) Filed: Feb. 23, 2006

(30) Foreign Application Priority Data
Feb. 28, 2005 (BR) 0500921-9

(51) Int. Cl. A01N 25/00

(52) U.S. Cl. 504/116.1

(57) ABSTRACT

The invention refers to a surfactant-based composition mainly applicable as an adjuvant for glyphosate family herbicides aqueous solutions, such as N-phosphonomethyl glycine, commonly used in the form of its salts, such as potassium salt. Composition based on surfactants mixture featured by comprising: (a) one or more alkoxylated alkyl amines; (b) one or more glycols and their derivatives or, yet, their mixtures; (c) optionally water.

The invention refers to a surfactant-based composition mainly applicable as an adjuvant for glyphosate family herbicides aqueous solutions, such as N-phosphonomethyl glycine, particularly used in the form of potassium salts, monoisopropylamine or monoethanolamine.

Pesticides play an important role in society, as they are responsible for the growing food production for mankind.

Pesticides formulations are composed by an active ingredient (with biological activity) and an adjuvant composition containing one or a mixture of surfactants.

The adjuvant's main role is to stabilize and enhance the active substance in order to more efficiently reach the target. The adjuvants' action is a complex process that affects the active ingredient spreading, adhesion and absorption on the vegetable surface, allowing the active ingredient to translocate from the vegetable surfaces to its inner layers transported via xylem and phloem.

Currently, adjuvants, as well as the active ingredient, have been recognized as indispensable agents for an improved agricultural performance.

Glyphosate salt-based herbicides are examples of the adjuvants use, because even being soluble in water; they require the addition of an adjuvant in order to meet the expected performance.

The U.S. Pat. No. 5,888,934 refers to a glyphosate-based composition with a higher than 210 g/L concentration of glyphosate with alkyl polyglucoside surfactant and ethoxylated alcohol containing 8 to 20 ethoxylation degrees in its chain, varying from 2 to 50 ethoxy (EO) groups moles, for every alcohol mole. Alkyl glucoside/ethoxylated alcohol rate may vary from 1:5 up to 8:1.

The Patent WO 0015037 refers to a highly resistant aqueous concentrated containing potassium glyphosate with a higher than 400 g/L concentration and surfactant: alkoxylated alkyl amine, preferably ethoxylated and/or propoxylated, containing 8 to 22 carbon atoms in the alkyl group and alkoxylation degree varying from 1 to 15 and still another surfactant, alkyl glucoside, considering that alkyl glucoside and alkoxylated amine rate may vary from 1:1 up to 5:1 parts in weight. Optionally, propylene glycol may be used as viscosity modifier. The purpose of this invention is almost totally based on alkyl glucoside's action. The intensive investigation of conventional surfactant systems has been emphasized showing it's quite difficult to reach surfactant effective levels providing a physically stable high concentration composition containing glyphosate salt such as the potassium one. Alkyl polyglucoside inconveniently attracts insects due to its odor and sugar content.

Conventional surfactant systems show that it is difficult to develop a surfactant mixture able to provide a highly stable potassium glyphosate solution.

Aiming to develop:
adjuvant composition to be used on herbicides formulation glyphosate-based;
surfactant compositions which are stable even at 54° C.;
compositions with lower costs than the conventionally known ones;
formulations showing stability at room temperature and homogeneous aspect or at least monophase;
formulations showing surfactant concentration lower than the one used on herbicides formulation glyphosate-based, commonly known;
formulations for which antifoam agents are not required as foam formation would be lower (mainly in the tank during herbicide application) than the convetional products known by those skilled in the art;
compositions showing efficient formulation, requiring lower herbicide concentration for its application causing lower environmental exposure.

A high performance adjuvant composition has been developed in order to be added to Glyphosate-based (N-phosphonomethyl glycine) herbicides formulation and to its respective salt, Potassium, Monoisopropylamine and Monoethanolamine.

This invention refers to a mixture of glycols and ethoxylated fatty amines, where glycol is the main agent that promotes synergy between ethoxylated fatty amines and respective glyphosate salt (N-phosphonomethyl glycine). The effect as a high performance adjuvant is related to final physical stability and synergetic mixture susceptibility to vegetable leaf surface, followed by surface tension reduction, enhancing herbicide absorption and translocation via vegetable's lymphatic system. The invention represents a technological breakthrough for those skilled in the art as the state-of-the-art documents proved that an efficient and stable, low surfactant content and low cost adjuvant composition was not believed to be possible.

The main Applicant's objective was to develop a high performance surfactant mixture showing stability concerning its trend to spread into two or more distinct phases. A high performance adjuvant composition has been developed to be added to herbicides based on N-phosphonomethyl glycine derivatives and their salts, with an homogeneous monophase appearance, comprising:
(a) one or more alkoxylated alkyl amines;
(b) one or more glycols and their derivatives or, yet, their mixtures;
(c) optionally water.

Alkyl amines may be non-saturated or not, containing alkyl groups with 8 to 22 linear or branched carbon atoms. Alkyl groups containing 16 to 18 carbon atoms are preferably used, as those derived from palmitic or hexadecanoic acid (C16), cis-9-hexadecenoic acid (C16:1), heptadecanoic acid (C17), cis-9-heptadecenoic acid (C17:1), stearic or octadecanoic acid (C18), oleic or cis-9-octadecenoic acid (C18:1), linoleic or cis-9, cis-12-octadecadienoic acid (C18:2), linoleic or cis-9, cis-12, cis-15-octadecatrienoic acid (C18:3), α-eleostearic or cis-9, trans-11, trans-13-octadecatrienoic acid (C18:3), 4-oxo-cis 9, trans-11, trans-13 octadecatrienoic acid (C18:3), ricinoleic or 12-hydroxy-cis-9-octadecenoic acid (C18:1), di-hydroxy stearic acid (C18), or from their mixtures. These alkyl amines may be of vegetable origin, preferably soybean, or animal origin, such as those found in tallow.

According to the purpose of the invention, it's possible to use an alkyl amine on composition showing an alkoxylation distribution degree from about 1 to about 20 of the alkoxylate. Although those skilled in the art believed that ethoxylated alkyl amines with high ethoxylation degree were not compatible with composition as those with lower ethoxylation degree due to viscosity issues, the Applicant developed a composition using alkyl amines with both high and low alkoxylation degree. So, an alkoxylation distribution (or ethoxylation, to be more specific) degree ranging about 5 to 15 is preferable. Alkoxy group preferably contains 2 or 3 carbon atom, preferably ethoxy or ethylene oxide and/or propylene oxide, preferably ethylene oxide. In order to solve the problem found by the technique man and also the viscosity problems, a viscosity modifier propylene glycol was used, but usually facing phase separation problems. The Applicant discovered that ethylene glycol solves both problems, concerning to viscosity and final mixture stability when used as an adjuvant for glyphosate solution or suspension formation, preferably potassium, maintaining its final stability.

Glycols or their derivatives, usable according to the invention, are selected among the group that includes: MEG (monoethylene glycol), DEG (diethylene glycol), TEG (triethylene glycol), PGI (propylene glycol), other types of ethylene glycol monomers and/or comonomers, or their mixtures, such as monoethylene glycol and diethylene glycol mixture, or monoethylene glycol and propylene glycol. MEG, monoethylene glycol or its derivatives are preferably used.

Ethylene glycol is not only a viscosity modifier, but also works as a synergizer for the final mixture stabilization maintaining herbicide n-phosphonomethyl glycine or glyphosate-based diluted on formulation helping its translocation to be easier over pulverized leaves' surface, besides its anti-freezing properties.

A preferable composition of the invention presents:
from about 40 to about 80% by weight of alkoxylated alkyl amines (a);
at least about 11% by weight of one or more glycol component (b), preferable at least about 25% by weight;
the presence of water (c) is from about 0 to about 10% by weight.

The surfactant mixture, known as adjuvant, when in solution or a stable dispersion in water may at least represent 60 g/L related to the pesticidal composition, particularly vary from about 90 to about 150 g/L.

The following examples are meant to illustrate but not to limit the invention.

### EXAMPLES—01 TO 06

### Glyphosate Monoisopropylamine Salt

### Example—1

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 33% w/w ethylene glycol and 4.0% w/w water. Mixture should be carried under moderate stirring at about 100 rpm and 60° C. [140° F.].

### Example—2

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 16.5% w/w ethylene glycol, 16.5% w/w diethylene glycol and 4.0% w/w water. Mixture should be carried under moderate stirring about 100 rpm and 60° C.

### Example—3

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 16.5% w/w ethylene glycol, 16.5% w/w propylene glycol and 4.0% w/w water. Mixture should be carried under moderate stirring about 100 rpm and 60° C.

### Example—4

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 33% w/w diethylene glycol and 4.0% w/w water. Mixture should be carried under moderate stirring about 100 rpm and 60° C.

### Example—5

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 16.5% w/w Diethylene glycol and 16.5% w/w propylene glycol. Mixture should be carried under moderate stirring about 100 rpm and 60° C.

### Example—6

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 33% w/w propylene glycol and 4.0% w/w water. Mixture should be carried under moderate stirring about 100 rpm and 60° C.

TABLE 1

| | Examples | | | | | |
|---|---|---|---|---|---|---|
| | 01 | 02 | 03 | 04 | 05 | 06 |
| Tallow Fatty Amine with 1 to | 58.0 | 58.0 | 58.0 | 58.0 | 58.0 | 58.0 |
| 9 moles EO | | | | | | |
| Tallow Fatty Amine with 10 | 5.0 | 5.0 | 5.0 | 5.0 | 5.0 | 5.0 |
| to 20 moles EO | | | | | | |
| Monoethylene glycol | 33.0 | | | | | |
| Monoethylene glycol/ | | 33.0 | | | | |
| Diethylene glycol 1:1 w/w | | | | | | |
| Monoethylene glycol/ | | | 33.0 | | | |
| Propylene glycol 1:1 w/w | | | | | | |
| Diethylene glycol | | | | 33.0 | | |
| Diethylene glycol/Propylene | | | | | 33.0 | |
| glycol 1:1 w/w | | | | | | |
| Propylene glycol 1:1 w/w | | | | | | 33.0 |
| Water | 4.0 | 4.0 | 4.0 | 4.0 | 4.0 | 4.0 |

Formulation Stability of N-phosphonomethy
glycine Monoisopropylamine salt 480 g/L
formulation, with 12% of adjuvant mixture

| | |
|---|---|
| 03 months aging 54° C. | Stable, free of turbidness, or phase |
| [130° F.] | separation |
| 03 months aging −10° C. | Stable, free of turbidness, or phase |
| [14° F.] | separation |

### EXAMPLES 07 TO 12

### Glyphosate Monoisopropylamine Salt

### Example—7

Mixture of 58% w/w alkoxylated tallow fatty amine with a distribution from about 1 to about 9 moles of ethylene oxide, add 38% w/w ethylene glycol and 4.0% w/w water. Mixture should be carried under moderate stirring about 100 rpm and 60° C.

### Example—8

Mixture of 58% w/w alkoxylated tallow fatty amine with a distribution from about 1 to about 9 moles of ethylene oxide, 19.0% w/w ethylene glycol, 19.0% w/w diethylene glycol and 4.0% w/w water. Mixture should be carried under moderate stirring about 100 rpm and 60° C.

### Example—9

Mixture of 58% w/w alkoxylated tallow fatty amine with a distribution from about 1 to about 9 moles of ethylene oxide, 19.0% w/w ethylene glycol 19.0% w/w propylene glycol and 4.0% w/w water. Mixture should be carried under moderate stirring about 100 rpm and 60° C.

### Example—10

### Example—10

Mixture of 58% w/w alkoxylated tallow fatty amine with a distribution from about 1 to about 9 moles of ethylene oxide, 38% w/w diethylene glycol and 4.0% w/w water. Mixture should be carried under moderate stirring about 100 rpm and 60° C.

### Example—11

Mixture of 58% w/w alkoxylated tallow fatty amine with a distribution from about 1 to about 9 moles of ethylene oxide, 19.0% w/w diethylene glycol and 19.0% w/w propylene glycol. Mixture should be carried under moderate stirring about 100 rpm and 60° C.

### Example—12

Mixture of 58% w/w alkoxylated tallow fatty amine with a distribution from about 1 to about 9 moles of ethylene oxide, 38.0% w/w propylene glycol and 4.0% w/w water. Mixture should be carried under moderate stirring about 100 rpm and 60° C.

TABLE 2

| | Examples | | | | | |
|---|---|---|---|---|---|---|
| | 07 | 08 | 09 | 10 | 11 | 12 |
| Tallow Fatty Amine with | 58.0 | 58.0 | 58.0 | 58.0 | 58.0 | 58.0 |
| 1 to 9 moles EO | | | | | | |
| Monoethylene glycol | 38.0 | | | | | |
| Monoethylene glycol/ | | 38.0 | | | | |
| Diethylene glycol 1:1 w/w | | | | | | |
| Monoethylene glycol/ | | | 38.0 | | | |
| Propylene glycol 1:1 w/w | | | | | | |
| Diethylene glycol | | | | 38.0 | | |
| Diethylene glycol/ | | | | | 38.0 | |
| Propylene glycol 1:1 w/w | | | | | | |
| Propylene glycol 1:1 w/w | | | | | | 38.0 |
| Water | 4.0 | 4.0 | 4.0 | 4.0 | 4.0 | 4.0 |

Stability formulation of N-phosphonomethy
glycine Monoisopropylamine salt 480 g/L
formulations, with 12% of adjuvant

| | |
|---|---|
| 03 months aging 54° C. | Stable, free of turbidness, or phase |
| [130° F.] | separation |
| 03 months aging −10° C. | Stable, free of turbidness, or phase |
| [14° F.] | separation |

### EXAMPLES—13 TO 18

### Glyphosate Potassium Salt

### Example—13

Mixture of 58% w/w alkoxylated tallow fatty amine with a distribution from about 1 to about 9 moles of ethylene oxide, with 5.0% w/w alkoxylated tallow fatty amine with distribution of 10 to 20 moles of ethylene oxide, then, add 33% w/w ethylene glycol and 4.0% w/w water. Mixture should be carried under moderate stirring about 100 rpm and 60° C.

### Example—14

Mixture of 58% w/w alkoxylated tallow fatty amine with a distribution from about 1 to about 9 moles of ethylene oxide, with 5.0% w/w alkoxylated tallow fatty amine with distribution of 10 to 20 moles of ethylene oxide, then, add 16.5% w/w ethylene glycol, 16.5% w/w diethylene glycol and 4.0% w/w water. Mixture should be carried under moderate stirring about 100 rpm and 60° C.

### Example—15

Mixture of 58% w/w alkoxylated tallow fatty amine with a distribution from about 1 to about 9 moles of ethylene oxide, with 5.0% w/w alkoxylated tallow fatty amine with distribution of 10 to 20 moles of ethylene oxide, then, add 16.5% w/w ethylene glycol, 16.5% w/w propylene glycol and 4.0% w/w water. Mixture should be carried under moderate stirring about 100 rpm and 600 C.

### Example—16

Mixture of 58% w/w alkoxylated tallow fatty amine with a distribution from about 1 to about 9 moles of ethylene oxide, with 5.0% w/w alkoxylated tallow fatty amine with a distribution from about 10 to 20 moles of ethylene oxide, then, add 33% w/w diethylene glycol and 4.0% w/w water. Mixture should be carried under moderate stirring about 100 rpm and 60° C.

### Example—17

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 16.5% w/w Diethylene glycol and 16.5% w/w Propylene glycol. Mixture should be carried under moderate stirring about 100 rpm and 60° C.

### Example—18

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 33% w/w propylene glycol and 3,5% w/w water. Mixture should be carried under moderate stirring about 100 rpm and 60° C.

TABLE 3

| | Examples | | | | | |
|---|---|---|---|---|---|---|
| | 13 | 14 | 15 | 16 | 17 | 18 |
| Tallow Fatty Amine with | 58.0 | 58.0 | 58.0 | 58.0 | 58.0 | 58.0 |
| 1 to 9 moles EO | | | | | | |
| Tallow Fatty Amine with | 5.0 | 5.0 | 5.0 | 5.0 | 5.0 | 5.0 |
| 10 to 20 moles EO | | | | | | |
| Monoethylene glycol | 33.0 | | | | | |
| Monoethylene glycol/ | | 33.0 | | | | |
| Diethylene glycol 1:1 w/w | | | | | | |
| Monoethylene glycol/ | | | 33.0 | | | |
| Propylene glycol 1:1 w/w | | | | | | |
| Diethylene glycol | | | | 33.0 | | |
| Diethylene glycol/ | | | | | 33.0 | |
| Propylene glycol 1:1 w/w | | | | | | |
| Propylene glycol 1:1 w/w | | | | | | 33.0 |
| Water | 4.0 | 4.0 | 4.0 | 4.0 | 4.0 | 4.0 |

Formulation Stability of N-phosphonomethyl
glycine Potassium salt 620 g/L
formulation with 12% w/w of adjuvant

| | |
|---|---|
| 03 months aging 54° C. | Stable, free of turbidness, or phase |
| [130° F.] | separation |
| 03 months aging −10° C. | Stable, free of turbidness, or phase |
| [14° F.] | separation |

### EXAMPLES—19 TO 24

### Glyphosate Potassium Salt

### Example—19

Mixture of 58% w/w alkoxylated tallow fatty amine with a distribution from about 1 to about 9 moles of ethylene oxide, add 38% w/w ethylene glycol and 4.0% w/w water. Mixture should be carried under moderate stirring about 100 rpm and 60° C.

### Example—20

Mixture of 58% w/w alkoxylated tallow fatty amine with a distribution from about 1 to about 9 moles of ethylene oxide, 19.0% w/w ethylene glycol, 19.0% w/w diethylene glycol and 4.0% w/w water. Mixture should be carried under moderate stirring about 100 rpm and 60° C.

### Example—21

Mixture of 58% w/w alkoxylated tallow fatty amine with a distribution from about 1 to about 9 moles of ethylene oxide, 19.0% w/w ethylene glycol, 19.0% w/w propylene glycol and 4.0% w/w water. Mixture should be carried under moderate stirring about 100 rpm and 60° C.

### Example—22

Mixture of 58% w/w alkoxylated tallow fatty amine with a distribution from about 1 to about 9 moles of ethylene oxide, 38% w/w diethylene glycol and 4.0% w/w water. Mixture should be carried under moderate stirring about 100 rpm and 60° C.

### Example—23

Mixture of 58% w/w alkoxylated tallow fatty amine with a distribution from about 1 to about 9 moles of ethylene oxide, 19.0% w/w diethylene glycol and 19.0% w/w propylene glycol. Mixture should be carried under moderate stirring about 100 rpm and 60° C.

### Example—24

Mixture of 58% w/w alkoxylated tallow fatty amine with a distribution from about 1 to about 9 moles of ethylene oxide, 38.0% w/w propylene glycol and 4.0% w/w water. Mixture should be carried under moderate stirring about 100 rpm and 60° C.

TABLE 4

| | Examples | | | | | |
|---|---|---|---|---|---|---|
| | 19 | 20 | 21 | 22 | 23 | 24 |
| Tallow fatty amine with | 58.0 | 58.0 | 58.0 | 58.0 | 58.0 | 58.0 |
| 1 to 9 moles EO | | | | | | |
| Monoethylene glycol | 38.0 | | | | | |
| Monoethylene glycol/ | | 38.0 | | | | |
| Diethylene glycol 1:1 w/w | | | | | | |
| Monoethylene glycol/ | | | 38.0 | | | |
| Propylene glycol 1:1 w/w | | | | | | |
| Diethylene glycol | | | | 38.0 | | |
| Diethylene glycol/ | | | | | 38.0 | |
| Propylene glycol 1:1 w/w | | | | | | |
| Propylene glycol 1:1 w/w | | | | | | 38.0 |
| Water | 4.0 | 4.0 | 4.0 | 4.0 | 4.0 | 4.0 |

Formulation Stability of N-phosphonomethyl
glycine Potassium salt 620 g/L
formulation with 12% w/w of adjuvant

| | |
|---|---|
| 03 months aging 54° C. | Stable, free of turbidness, or phase |
| [130° F.] | separation |
| 03 months aging −10° C. | Stable, free of turbidness, or phase |
| [14° F.] | separation |

### EXAMPLES—25 TO 30

### Glyphosate Monoethanolamine Salt

### Example—25

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 33% w/w ethylene glycol and 4.0% w/w water. Mixture should be carried under moderate stirring about 100 rpm and 60° C.

### Example—26

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 16.5% w/w ethylene glycol, 16.5% w/w diethylene glycol and 4.0% w/w water. Mixture should be carried under moderate stirring about 100 rpm and 60° C.

### Example—27

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 16.5% w/w ethylene glycol, 16.5% w/w Propylene glycol and 4.0% w/w water. Mixture should be carried under moderate stirring about 100 rpm and 60° C.

### Example—28

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 33% w/w diethylene glycol and 4.0% w/w water. Mixture should be carried under moderate stirring about 100 rpm and 60° C.

### Example—29

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 16.5% w/w Diethylene glycol and 16.5% w/w propylene glycol. Mixture should be carried under moderate stirring about 100 rpm and 60° C.

### Example—30

Mixture of 58% w/w alkoxylated tallow fatty amine with a distribution from about 1 to about 9 moles of ethylene oxide, with 5.0% w/w alkoxylated tallow fatty amine with a distribution from about 10 to about 20 moles of ethylene oxide, then, add 33% w/w propylene glycol and 4.0% w/w water. Mixture should be carried under moderate stirring about 100 rpm and 60° C.

TABLE 5

| | Examples | | | | | |
|---|---|---|---|---|---|---|
| | 25 | 26 | 27 | 28 | 29 | 30 |
| Tallow Fatty Amine with | 58.0 | 58.0 | 58.0 | 58.0 | 58.0 | 58.0 |
| 1 to 9 moles EO | | | | | | |
| Tallow Fatty Amine with | 5.0 | 5.0 | 5.0 | 5.0 | 5.0 | 5.0 |
| 10 to 20 moles EO | | | | | | |
| Monoethylene glycol | 33.0 | | | | | |
| Monoethylene glycol/ | | 33.0 | | | | |
| Diethylene glycol 1:1 w/w | | | | | | |
| Monoethylene glycol/ | | | 33.0 | | | |
| Propylene glycol 1:1 w/w | | | | | | |
| Diethylene glycol | | | | 33.0 | | |
| Diethylene glycol/ | | | | | 33.0 | |
| Propylene glycol 1:1 w/w | | | | | | |
| Propylene glycol 1:1 w/w | | | | | | 33.0 |
| Water | 4.0 | 4.0 | 4.0 | 4.0 | 4.0 | 4.0 |

Formulation stability of N-fosfonometilglicina
Monoethanolamine salt 480 g/L
formulation with 12% w/w of adjuvant

| | |
|---|---|
| 03 months aging 54° C. | Stable, free of turbidness, or phase |
| [130° F.] | separation |
| 03 months aging −10° C. | Stable, free of turbidness, or phase |
| [14° F.] | separation |

### EXAMPLES—31 TO 36

### Glyphosate Monoethanolamine Salt

### Example—31

Mixture of 58% w/w alkoxylated tallow fatty amine with a distribution from about 1 to about 9 moles of ethylene oxide, add 38% w/w ethylene glycol and 4.0% w/w water. Mixture should be carried under moderate stirring about 100 rpm and 60° C.

### Example—32

Mixture of 58% w/w alkoxylated tallow fatty amine with a distribution from about 1 to about 9 moles of ethylene oxide, 19.0% w/w ethylene glycol, 19.0% w/w diethylene glycol and .3,5% w/w water. Mixture should be carried under moderate stirring about 100 rpm and 60° C.

### Example—33

Mixture of 58% w/w alkoxylated tallow fatty amine with a distribution from about 1 to about 9 moles of ethylene oxide, 19.0% w/w ethylene glycol, 19.0% w/w propylene glycol and 4.0% w/w water. Mixture should be carried under moderate stirring about 100 rpm and 60° C.

### Example—34

Mixture of 58% w/w alkoxylated tallow fatty amine with a distribution from about 1 to about 9 moles of ethylene oxide, 38% w/w diethylene glycol and 4.0% w/w water. Mixture should be carried under moderate stirring about 100 rpm and 60° C.

### Example—35

Mixture of 58% w/w alkoxylated tallow fatty amine with a distribution from about 1 to about 9 moles of ethylene oxide, 19.0% w/w diethylene glycol and 19.0% w/w propylene glycol. Mixture should be carried under moderate stirring about 100 rpm and 60° C.

### Example—36

Mixture of 58% w/w alkoxylated tallow fatty amine with a distribution from about 1 to about 9 moles of ethylene oxide, 38.0% w/w propylene glycol and 4.0% w/w water. Mixture should be carried under moderate stirring about 100 rpm and 60° C.

TABLE 6

| | Examples | | | | | |
|---|---|---|---|---|---|---|
| | 31 | 32 | 33 | 34 | 35 | 36 |
| Tallow fatty Amine with | 58.0 | 58.0 | 58.0 | 58.0 | 58.0 | 58.0 |
| 1 to 9 moles EO | | | | | | |
| Monoethylene glycol | 38.0 | | | | | |
| Monoethylene glycol/ | | 38.0 | | | | |
| Diethylene glycol 1:1 w/w | | | | | | |
| Monoethylene glycol/ | | | 38.0 | | | |
| Propylene glycol 1:1 w/w | | | | | | |
| Diethylene glycol | | | | 38.0 | | |
| Diethylene glycol/ | | | | | 38.0 | |
| Propylene glycol 1:1 w/w | | | | | | |
| Propylene glycol 1:1 w/w | | | | | | 38.0 |
| Water | 4.0 | 4.0 | 4.0 | 4.0 | 4.0 | 4.0 |

Fomrulation Stability of N-phosphonomethyl
glycine Monoethanolamine salt 480 g/L
formulation with 12% w/w of adjuvant

| | |
|---|---|
| 03 months aging 54° C. | Stable, free of turbidness, or phase |
| [130° F.] | separation |
| 03 months aging −10° C. | Stable, free of turbidness, or phase |
| [14° F.] | separation |

Stability studies carried on “formulations 1 to 36” Glyphosate (N-phosphonomethyl glycine) and its respective salts, at 54° C. and at −10° C. during three months, showed stable physical aspects.

1. High performance adjuvant composition used on herbicides formulation based on N-phosphonomethyl glycine derivatives and their salts, comprising:
(a) one or more alkoxylated alkyl amines; and
(b) one or more glycols, their derivatives or mixtures thereof.

2. High performance adjuvant composition used on herbicides formulation based on N-phosphonomethyl glycine derivatives and their salts according to claim 1, comprising saturated or non-saturated alkyl amines, in which the alkyl group contains from 8 to 22 linear or branched carbon atoms.

3. High performance adjuvant composition used on herbicides formulation based on N-phosphonomethyl glycine derivatives and their salts according to claim 2 wherein the alkyl amines contain alkyl groups having from about 16 to about 18 carbon atoms.

4. High performance adjuvant composition used on herbicides formulation based on N-phosphonomethyl glycine derivatives and their salts according to claim 3 wherein the alkyl amines are selected from the group consisting of: palmitic or hexadecanoic acid (C16), cis-9-hexadecenoic acid (C16:1), heptadecanoic acid (C17), cis-9-heptadecenoic acid (C17:1), stearic or octadecanoic acid (C18), oleic e or cis-9-octadecenoic acid (C18:1), linoleic or cis-9, cis-12-octadecadienoic acid (C18:2), linoleic or cis-9, cis-12, cis-I5-octadecatrienoic acid (C18:3), a-eleostearic or cis-9, trans-11, trans-13-octadecatrienoic acid (C18:3), 4-oxo-cis 9, trans-11, trans-13 octadecatrienoic acid (C18:3), ricinoleic or 12-hydroxy-cis-9-octadecenoic acid (C 18:1), di-hydroxy stearic acid (C18) or, yet, from their mixtures thereof.

5. High performance adjuvant composition used on herbicides formulation based on N-phosphonomethyl glycine derivatives and their salts according to claim 1 that wherein the alkyl amines are from vegetable or animal origin.

6. High performance adjuvant composition used on herbicides formulation based on N-phosphonomethyl glycine derivatives and their salts according to claim 5 in which the alkyl amine is tallow alkanolamine.

7. High performance adjuvant composition used on herbicides formulation based on N-phosphonomethyl glycine derivatives and their salts according to claim 5 in which the alkyl amine is soybean alkanolamine.

8. High performance adjuvant composition used on herbicides formulation based on N-phosphonomethyl glycine derivatives and their salts according to claim 1 wherein the alkyl amines have an alkoxylation degree of about 1 to 20.

9. High performance adjuvant composition used on herbicides formulation based on N-phosphonomethyl glycine derivatives and their salts according to claim 1 wherein the alkoxy group has 2 or 3 carbon atoms.

10. High performance adjuvant composition used on herbicides formulation based on N-phosphonomethyl glycine derivatives and their salts according to claim 9 wherein the alkoxy group is ethylene oxide.

11. High performance adjuvant composition used on herbicides formulation based on N-phosphonomethyl glycine derivatives and their salts according to claim 1 wherein the glycols are selected from the group consisting of monoethylene glycol, diethylene glycol, triethylene glycol, propylene glycol, ethylene glycol monomers, ethylene glycol comonomers or mixtures thereof.

12. High performance adjuvant composition used on herbicides formulation based on N-phosphonomethyl glycine derivatives and their salts according to claim 11 wherein the glycol is monoethylene glycol or its derivatives.

13. High performance adjuvant composition used on herbicides formulation based on N-phosphonomethyl glycine derivatives and their salts according to claim 1 wherein the alkoxylated alkyl amine is present in an amount of from about 40 to about 80% by weight based on the weight of the composition.

14. High performance adjuvant composition used on herbicides formulation based on N-phosphonomethyl glycine derivatives and their salts according to claim 1 wherein the glycol component comprises at least about 11% by weight based on the weight of the composition.

15. High performance adjuvant composition used on herbicides formulation based on N-phosphonomethyl glycine derivatives and their salts according to claim 14 wherein the glycol component comprises at least about 25% by weight based on the weight of the composition.

16. High performance adjuvant composition used on herbicides formulation based on N-phosphonomethyl glycine derivatives and their salts according to claim 1 further comprising water in an amount up to about 10% by weight based on the weight of the composition.

17. High performance adjuvant composition used on herbicides formulation based on N-phosphonomethyl glycine derivatives and their salts according to claim 1 further comprising a surfactant.

18. High performance adjuvant composition used on herbicides formulation based on N-phosphonomethyl glycine derivatives and their salts according to claim 17 wherein the surfactant is present in an amount of from about 60 g/L to about 150 g/l.

19. High performance adjuvant composition used on herbicides formulation based on N-phosphonomethyl glycine derivatives and their salts according to claim 1 comprising a potassium, monoisopropylamine or monoethanolamine salt of n-phosphonomethyl glycine.
